(19) United States
(12) Patent Application Publication
(10) Pub. No.: US 2010/0205584 A1
(43) Pub. Date: Aug. 12, 2010

(54) METHOD AND APPARATUS FOR DETERMINING AUTHORITATIVENESS OF FIRST SOFTWARE COMPONENT WITH REGARD TO SECOND SOFTWARE COMPONENT

(75) Inventors: Michael JAEGER, Munich (DE); Cal-Nicolas Ziegler, Munich (DE)

Correspondence Address: STAAS & HALSEY LLP, SUITE 700, 1201 NEW YORK AVENUE, N.W., WASHINGTON, DC, 20005, US

(73) Assignee: Siemens Aktiengesellschaft, Munich (DE)

(21) Appl. No.: 12/399,631

(22) Filed: Mar. 6, 2009

(30) Foreign Application Priority Data
Feb. 6, 2009 (EP) 09001673

(51) Int. Cl. G06F 9/44

(52) U.S. Cl. 717/133

(57) ABSTRACT

For identification of the quality of trustworthiness and reliability of software components, an eigenvector based approach is used in which a procedure invocation graph of a set of software components is provided. Subsequently, the authoritativeness of a first software component is calculated as a function of an eigenvector of the provided procedure invocation graph. For calculating the authoritativeness, a flexible algorithm, which considers background knowledge is used. Applying the method, software code can be analyzed more efficiently. The method can be applied in software code analysis and/or in software architecture analysis.

### CROSS REFERENCE TO RELATED APPLICATIONS

This application is based on and hereby claims priority to European Application No. 09001673 filed on Feb. 6, 2009, the contents of which are hereby incorporated by reference.

### BACKGROUND

Described below are a method and an apparatus for source code analysis and increasing the efficiency of source code maintenance.

Architectures of software systems are typically very extensive and complex, involving a variety of software components which interact, for instance by method or procedure invocations. These software components may be potentially used by several software applications. For providing reliable software components maintenance, adaptations and error elimination in the source code is highly required. It is therefore of interest for a source code analyst to identify frequently used software components, which play a central role for a software product.

Therefore, software analysts and software architects are constantly faced with analyzing software's architecture with regard to centrality indicators, such as the extent of interdependencies between software components or the coherence of software modules. An interdependency between two software components may be given in case one software component invokes a method of another software component. A software component's importance can be evaluated by measuring its centrality as regards other interacting software components. Once very central software components are identified, maintenance efforts can be directed to these selected software components, instead of spending effort on software components playing a minor role for the overall software product.

In addition to a static code analysis, execution and runtime performance of software components are likewise of importance, for instance for identification of a so-called bottleneck. A bottleneck may be represented by a set of software components with low execution and/or runtime performance, which lowers the overall execution or runtime performance of the software product. An identification of bottlenecks may be performed during an execution of the software product.

For performing software architecture analysis known methods apply graph structure based approaches. A graph may include nodes and edges. A node label may represent a software component, while edges may represent method invocations between the software components. The resulting graph structure may include directed edges, undirected edges and/or cycles. In dependence of the graph structure, an evaluation metric for software architecture analysis is applied.

Known methods relying on an aforementioned graph structure, also referred to as call graphs and/or method invocation graph, may not distinguish different node types. This may be the case if the evaluation metric only considers ingoing and outgoing edges of nodes. Known methods may for instance determine the absolute number of ingoing and outgoing edges for each node and directly derive a centrality value for each node. This evaluation metric is questionable as software components may be referred to at high frequency, although they do not contribute to the functionality of the overall software product. The nodes presenting the software components may then hold a high number of ingoing and outgoing edges, although they do not contribute to the business logic of the software product. This may be the case if a software component provides a logging functionality. Methods of this software component may be invoked frequently, although it behaves in a passive fashion as regards the functionality provided by the overall software product.

Commonly known methods applied in software engineering and architecture analysis may rely on the PageRank algorithm. Such methods typically applied in internet search engines for link analysis of web pages. Although methods relying on the PageRank algorithm may potentially be applied in the domain of software architecture analysis, they still lack precision, as the centrality value is calculated as a function of the absolute number of ingoing and outgoing edges per node, without distinguishing the contribution of a software component as regards the functionality provided by the overall software product.

Commonly known methods in the field of software architecture analysis do not apply a differentiated concept, which reflects the quality of trustworthiness and reliability of software components as regards other software components. The quality of trustworthiness and reliability is also referred to the authoritativeness of a first software component with regard to a second software component. Commonly known methods aiming at software design analysis do not apply eigenvector-based approaches for finding the authoritativeness of software components.

Existing software design analysis projects typically capture the inbound and outbound dependencies among classes and packages of software components. The software product “Classycle” focuses on the recognition of dependencies cycles and the length of possible path resulting from dependency relations. Besides covering the dependency, the “JDepend” software product offers metrics also involving an inheritance hierarchy. Applying the metrics, software developers can assess the grade of “structuredness” in an object model of a software product. Further software analysis projects implementing commonly known metrics may rely on the identification of predefined software code patterns, which are known to be error-prone.

A further software design analysis project implementing commonly known methods is named “Structure101”. This software design analysis project targets the analysis of dependencies relations and offers a graphical view on a dependency graph as well as a metrics view. The metrics view puts two entities of the software product into a weighted relation expressing the dependencies between these two entities. Additionally, metrics considering the structural complexity and the existence of cycles in the call graph are applied.

The aforementioned commonly known methods do not provide metrics considering a measure determining the contribution of single software components as regards the overall functionality of a software product. Furthermore they do not apply background knowledge regarding metrics being applied in the domain of software design analysis and/or architecture analysis, as they are only adapted from search engine technology in a straight forwarded fashion. What is required is an improved method for determining the quality of trustworthiness and reliability of software components, which is also referred to as the authoritativeness of a software component. Such an improved method may potentially reduce software maintenance, costs, increase software maintenance speed and may furthermore increase the reliability of a software product.

Therefore, an aspect is to provide an improved method for software architecture analysis, allowing an efficient maintenance of software products, which increases reliability and trustworthiness of the overall software product.

### SUMMARY

This disclosure provides a method for determining an authoritativeness of a first software component with regard to a second software component, wherein the first software component invokes an execution of at least one procedure executed by the second software component, including providing a procedure invocation graph of the first software component and the second software component; and calculating the authoritativeness of the first software component as a function of an eigenvector of the procedure invocation graph.

In an embodiment of the method, determining the procedure invocation graph includes determining an adjacency matrix, the adjacency matrix defining the procedure invocation graph.

According to another aspect, the procedure invocation graph includes a plurality of nodes and a plurality of edges, each node representing one software component and each edge representing a method invocation between the software components.

According to another aspect, the eigenvector is calculated by applying a Hyperlink-Induced Topic Search (HITS) algorithm.

According to another aspect, the eigenvector is calculated by applying a combination of the PageRank algorithm and the HITS algorithm.

According to another aspect, applying the HITS algorithm includes calculating at least one of a group of ranks, including a Hub rank and an Authority rank.

According to another aspect, the eigenvector is calculated by a combined rank as a function of the Hub rank and the Authority rank.

According to another aspect, calculating the combined rank is performed as a function of a summation of the Hub rank and the Authority rank.

According to another aspect, a software component includes a library, a repository, a module, a package, a class, an interface, a procedure, and/or a software unit.

Furthermore, an apparatus for determining an authoritativeness of the first software component with regard to a second software component, wherein the first software component invokes an execution of at least one procedure executed by the second software component, is provided, including units providing a procedure invocation graph of the first software component and the second software component and calculating the authoritativeness of the first software component as a function of an eigenvector of the procedure invocation graph.

Furthermore, a computer for determination of an authoritativeness of a first software component with regard to a second software component, wherein the first software component invokes an execution of at least one procedure executed by the second software component, is provided, including a first device for provision of a procedure invocation graph of the first software component and the second software component; and a second device for calculation of the authoritativeness of the first software as a function of an eigenvector of the procedure invocation graph.

In an embodiment, the first device and/or the second device are formed by a calculation unit.

Furthermore, a computer program product being adapted to perform an execution of at least one of the aforementioned methods on a computer, is provided.

### BRIEF DESCRIPTION OF THE DRAWINGS

These and other aspects and advantages will become more apparent and more readily appreciated from the following description of the exemplary embodiments, taken in conjunction with the accompanying drawings of which:

FIG. 1 is a block diagram of one embodiment of an apparatus for determining an authoritativeness of a first software component with regard to a second software component;

FIG. 2 is a detailed block diagram of one embodiment of an apparatus for determining an authoritativeness of a first software component with regard to a second software component;

FIG. 3 is a flow chart of one embodiment of a method for determining an authoritativeness of a first software component with regard to a second software component;

FIG. 4 is a detailed flow chart of one embodiment of a method for determining an authoritativeness of a first software component with regard to a second software component;

FIG. 5 is a block diagram of one embodiment of a method for determining an authoritativeness of a first software component with regard to a second software component;

FIG. 6 is a table providing an evaluation result of a method for determining an authoritativeness of a first software component with regard to a second software component; and

FIG. 7 is a table providing a further evaluation result of a method for determining an authoritativeness of a first software component with regard to a second software component.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

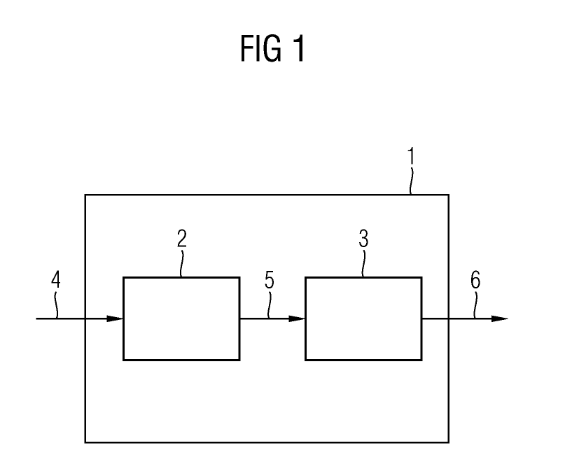

FIG. 1 shows a block diagram of one embodiment of an apparatus for determining an authoritativeness of a first software component with regard to a second software component, and includes a first unit 2 for provision of a procedure invocation graph 5, and a second unit 3 calculating the authoritativeness of a first software component with regard to a second software component.

In the present embodiment the authoritativeness of each software component in a set of software components 4 is determined. Therefore, a set of software components 4 serves as input of the first unit 2 providing a procedure invocation graph 5. The first 2 analyzes the set of software components 4. As a function of the analysis of the set of software components 4, the first unit 2 calculates a procedure invocation graph 5, which is transmitted to the second unit 3 to calculate the authoritativeness 6 of a first software component with regard to a second software component. The first and the second software components are in the set of software components 4. The calculation of the authoritativeness 6 of the first software component is accomplished as a function of an eigenvector of the procedure invocation graph 5, provided by the first unit 2. The calculated authoritativeness 6 serves as output.

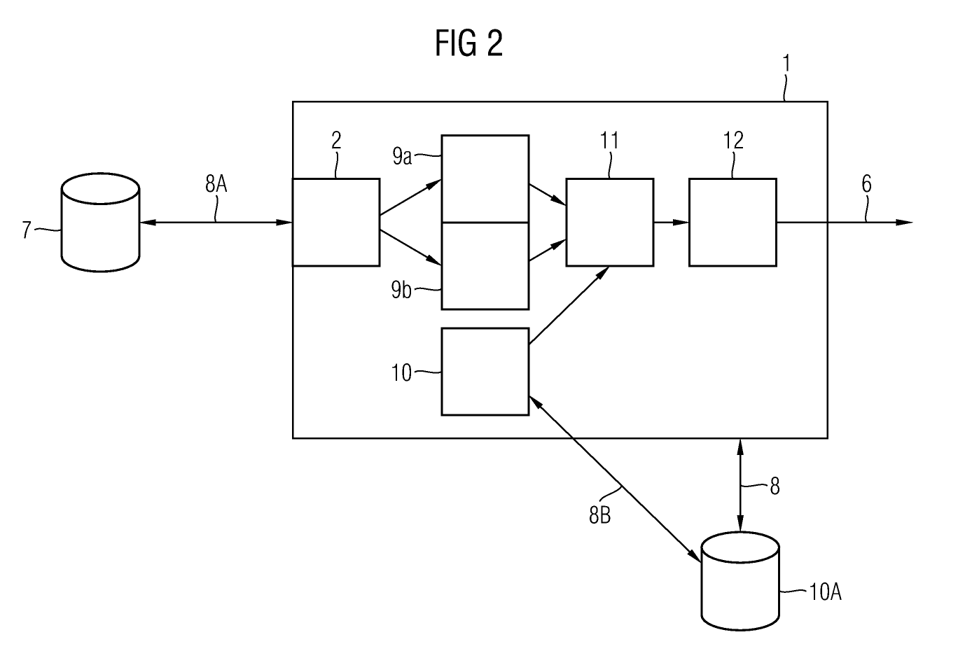

FIG. 2 shows a detailed block diagram of one embodiment of the apparatus 1 for determining an authoritativeness 6 of a first software component with regard to a second software component, and differs from the apparatus 1 as described in FIG. 1 as follows:

In the present embodiment the set of software components 4 is in a memory device 7. The set of software components 4 is transmitted to the first unit 2. The transmission of the set of software components 4 is accomplished over a data connection 8A.

In the present embodiment a first unit 2 providing a procedure invocation graph 5 is arranged to identify single software components and their relations. A software component may be, for instance, a library, a repository, a module, a package, a class, an interface, a procedure and/or a software unit.

In the present embodiment the set of software components 4 implements a software product. The set of software components provides an overall functionality which is established through the interaction of each of the software components in the set of software components 4. It is of interest for a software analyst and/or a software architect to determine the authoritativeness of each of the software components in a set of software components 4.

In the present embodiments the authoritativeness of software components is determined by the quality of the trustworthiness and/or the reliability of each of the software components in the set of software components 4. Therefore, the first unit 2 providing a procedure invocation graph 5 identifies each software component in the set of software components 4 and assigns each of the identified software components one node. Furthermore, the first unit 2 also identifies procedure invocations between the identified software components, and assigns each procedure invocation one edge. Hence, the first unit 2 also determines nodes and edges, which form one procedure invocation graph 5. The procedure invocation graph 5 models the set of software components 4 by nodes and edges. Each node may have one node label, which states an identification of the respective software component. A software component may be identified by an index, an URL, an URI, a path, a name and/or any alphanumerical string.

An edge may be directed or undirected. An undirected edge connects pairwise nodes, and indicates a procedure invocation of one of the pair of nodes to the other respective node. Directed edges may indicate which software component invokes an execution of at least one procedure, and which software component executes the procedure.

The procedure invocation graph 5 can be visualized by geometrical elements, such as a visualization of nodes and edges. It can also be described by an adjacency matrix. Hence, the procedure invocation graph 5 relates to the logical concept of a graph, which may imply that any specification of a graph structure can potentially by applied for describing the procedure invocation graph 5. Therefore, the procedure invocation graph 5 may also be represented by a table containing at least one name of each of the software components in a set of software components 4, an indegree and/or an outdegree. The indegree and the outdegree specify the absolute number of procedure invocations by the respective component.

The calculated procedure invocation graph 5 is transmitted to a authority calculation unit 9A and a Hub calculation unit 9B. The Authority calculation unit 9A calculates one authority rank for each node of the procedure invocation graph 5. The Hub calculation unit 9B calculates one Hub rank for each of the nodes of the procedure invocation graph 5. Calculating the Authority rank and/or the Hub rank can be accomplished by application of the HITS algorithm and/or the PageRank algorithm. Therefore in the following sections the HITS algorithm and the page rank algorithm are explained in detail.

The HITS algorithm is a bi-modal algorithm that computes, for each node one Authority rank and one Hub rank. A node's Authority rank indicates the node's reputation. The Authority rank of a node derives from the Hub rank of all nodes that have an edge being incident to the node at hand. A node's Hub rank indicates the node's ability to recommend further nodes, as each outgoing edge can be seen as an endorsement of the node being referenced. The Hub rank of a given node depends on the Authority ranks of the nodes it refers to. The HITS algorithm performs a series of iterations, each including two basic operations: Performing an Authority update and performing a Hub update. Performing an Authority update includes updating each node's Authority rank to be equal to the sum of the Hub ranks of each node that points to it. Performing a Hub update, includes updating each node's Hub score to be equal to the sum of the Authority scores of each node that it points to.

The Hub rank and the Authority rank for each node may be calculated by the following algorithm: First, the Hub rank and the Authority rank of each node are initialized with a rank of 1. Subsequently, the Authority update may be performed. Next, the Hub update may be performed. Then, optionally each rank is normalized by dividing each Hub rank by the sum of all Hub ranks, and dividing each Authority rank by the sum of all Authority ranks. The aforementioned operations may be performed iteratively and/or in different order especially performing the Authority update, performing the Hub update and/or the normalization.

The PageRank algorithm is based on complex recursive computations that aim at finding the eigenvector of the call graph's adjacency matrix, by iterative fix point calculations. Intuitively, a node's rank is higher the higher the rank of the nodes are, that link to the node at hand. A first node that is referenced for instance by three other nodes may have a better rank than a second node that is referenced by five nodes, because this three referencing nodes have higher ranks than the referencing nodes of the second node.

The Authority calculation unit 9A may calculate the Authority rank according to the aforementioned algorithm. One can also calculate the Authority rank by the PageRank algorithm. The Authority rank and/or the Hub rank represent an eigenvector of the procedure invocation graph 5. One can therefore calculate the eigenvector by applying the HITS algorithm. One can also calculate the eigenvector by applying a combination of the PageRank algorithm and the HITS algorithm. Applying the HITS algorithm may include calculating the Hub rank and the Authority rank. By calculating the Authority rank by the PageRank algorithm a combination of the PageRank algorithm and the HITS algorithm is applied. This method may hold the advantage that a flexible algorithm may be applied for calculating the eigenvector of the procedure invocation graph 5.

One can also calculate the eigenvector by a combined rank as a function of the Hub rank and the Authority rank. A combined rank can be calculated as a function of a summation of the Hub rank and the Authority rank. It may be of advantage to add additional summands to the summation. In the present embodiment a weighting factor wf is considered in the summation, which weights the influence of the Authority rank as regards the calculation of the combined rank. Therefore, a linear combination of the Hub rank, and the weighted Authority rank can be applied for calculation of the combined rank as follows:

Combined rank(n)=Hub rank(n)+wf×Authority rank(n)

Hence, the combined rank for each node n is calculated by a summation of the Hub rank of each node n and the weighted Authority rank of each node n. It may be of advantage to determine the weighting factor wf empirically. For instance, it may be of advantage to sign the number of five to the weighting factor wf. This may provide the advantage that applying a weighting factor wf of five complies with human intuition of which software components are to be considered authoritative.

It may be of advantage that a flexible algorithm, can be applied for calculating the authoritativeness of a first software component with regard to a second software component. Flexibility is granted through a summation with a domain specific number of summands, which may also be weighted. By empirically determining the weighting factor wf background knowledge of the application domain of the described method can be considered.

For determining the weighting factor wf a weighting factor determining unit may query a memory device 10A. Hence, the weighting factor wf is stored in the memory device 10A and is transmitted to the weighting factor determining unit 10. For transmitting the weighting factor wf a data connection 8B may be used. The weighting factor determining unit 10 may also be arranged to calculate the weighting factor wf.

The Authority rank, the Hub rank and the weighting factor wf are transmitted to a combined rank calculation unit 11. The combined rank calculation unit 11 calculates a combined rank for each node, for instance by applying the aforementioned formula for the “combined rank (n)”. The calculated combined rank may be transmitted to an authoritativeness calculation unit 12. The authoritativeness is calculated as a function of the combined rank. It may be the case, that the authoritativeness is equal to the combined rank. It may alternatively be the case, that further operations such as a normalization of the combined rank is required for calculating the authoritativeness. The calculated authoritativeness represents the output of the apparatus 1 for determining the authoritativeness 6 of a first software component with regard to a second software component.

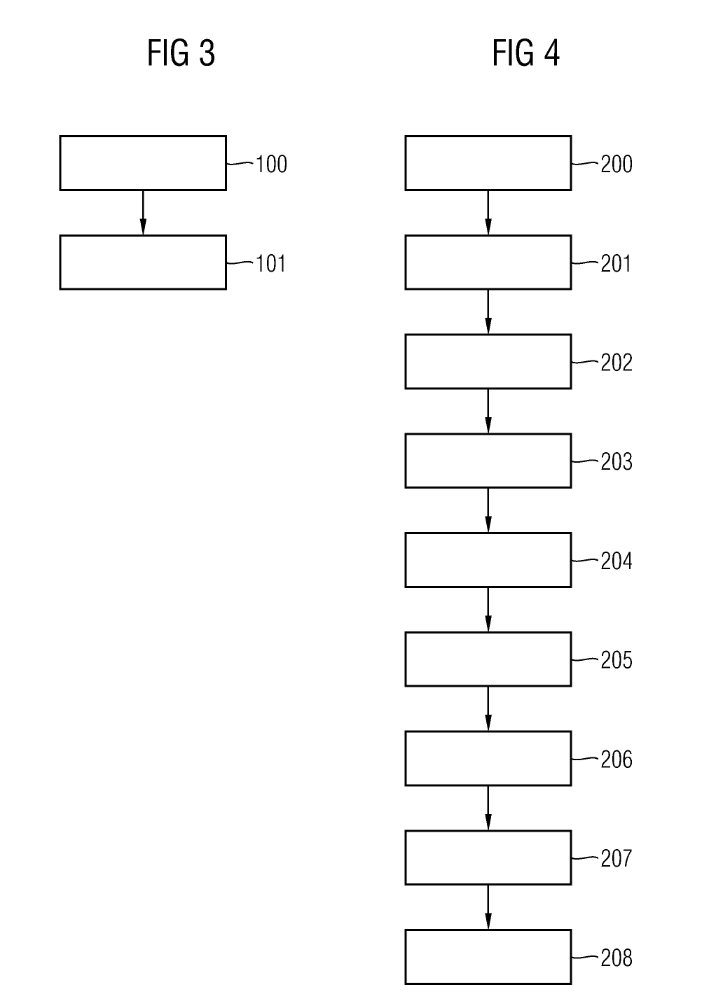

FIG. 3 shows a flow chart of one embodiment of a method for determining an authoritativeness of a first software component with regard to a second software component, as described below:

At 100, a procedure invocation graph of a first software component and a second software component is provided. Subsequently, at 101 the authoritativeness of the first software component is calculated as a function of an eigenvector of the procedure invocation graph.

FIG. 4 shows a detailed flow diagram of one embodiment of a method for determining an authoritativeness of a first software component with regard to a second software component, as described below:

At 200, software components are identified out of a set of software components 4. Subsequently, at 201 method invocations of the software components are identified. Subsequently, at 202 the software components identified in operation 200 and the method invocations identified in operation 201 are modelled as a call graph. A call graph may also be referred to as a procedure invocation graph 5. A method invocation may also be referred to as a procedure invocation.

Subsequently, at 203 a Hub rank for each of the nodes being comprised in the procedure invocation graph 5 is calculated. Subsequently, at 204 a weighting factor wf is calculated. This may be performed by a look up in a data base, the data base being comprised in a memory device. Alternatively the weighting factor wf can be calculated, which may comprise empirically determining the weighting factor wf. Subsequently, at 205 an Authority rank is calculated. This may be accomplished as a function of the PageRank algorithm. It may be of advantage, to accomplish operations 203 and 205 in a different order depending on the applied algorithm for calculation of the Hub rank and/or the Authority rank. Subsequently, at 206 the weighting factor wf, as identified in operation 204 and the Authority rank, as identified in operations 205 are multiplied. Subsequently, at 207 the weighted Authority rank, is calculated in step 206 and the Hub rank as determined in operation 203 are summed up. Optionally, at 208 a normalization of the output value of operation 207 may be required. The normalization of the combined rank as calculated in operation 207 represents the authoritativeness of the software component.

It may be of advantage to perform a selection of the aforementioned operations iteratively or in another order.

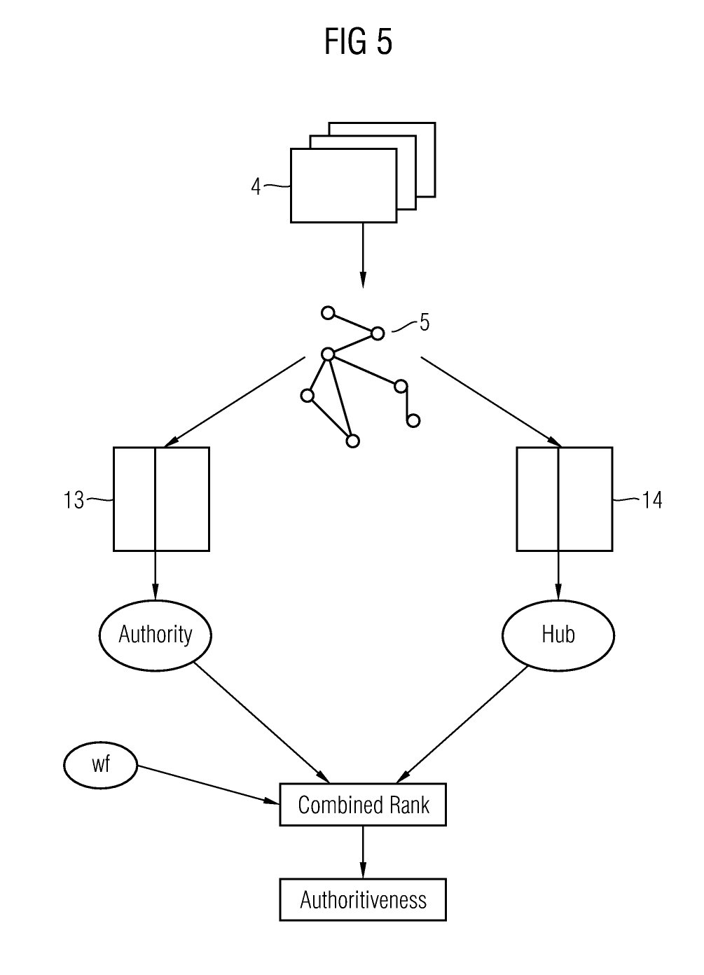

FIG. 5 shows an illustration of the method for determining an authoritativeness of a first software component with regard to a second software component.

First, a set of software components 4 is provided. The set of software components 4 includes several software components. In the present embodiment software components are classes, which in their entireness represent a software product. Each class holds a set of procedures. The overall functionality of the software product is provided through the interaction of the classes. An interaction of classes is performed by procedure invocations. A procedure invocation graph 5 is calculated as a function of the set of software components 4. It may be accomplished by a first unit providing a procedure invocation graph 5. Each software component is represented by one node of the graph, while each procedure invocation is represented by one edge of the procedure invocation graph 5.

Subsequently, the procedure invocation graph 5 is analyzed. Analyzing the procedure invocation graph 5 may include the creation of a table 13 indicating the ingoing edges for each node. Analyzing the procedure invocation graph 5 may further include creating a table 14 stating the outgoing edges of each node. The tables 13 and 14 may contain a name of each software component and/or an index of each software component and the respective number of in- and outgoing edges.

Subsequently, the Authority rank and the Hub rank are calculated. Furthermore, the weighting factor wf is determined. The Authority rank, the Hub rank and the weighting factor wf may serve as input for calculation of the combined rank. In the present embodiment the Authority rank and/or the Hub rank form an eigenvector of the procedure invocation graph 5. Generally, an eigenvector of a linear transformation is a non-zero vector, which, when a trans-formation is applied to it, may change in length but not the direction. Hence, the combined rank describes the procedure invocation graph 5 in any iteration of the applied algorithm. Applying iterative operations of the combined rank calculation algorithm does hence not affect the eigenvector of the procedure invocation graph 5.

Subsequently, the authoritativeness of the first software component is calculated as a function of the eigenvector of the procedure invocation graph 5. This may be accomplished by the second unit 3 calculating the authoritativeness of the first software component. Hence, the authoritativeness is calculated as a function of an eigenvector of the procedure invocation graph 5.

The described first unit 2 providing a procedure invocation graph 5 and the second unit 3 calculating the authoritativeness may be formed by a single, or by separated processors, microprocessors, computers, computer systems, Central Processing Units, arithmetic calculation units and/or circuits. This holds also for the introduced calculation units, such as the Authority calculation unit 9A, the Hub calculation unit 9B, the weighting factor wf determination unit 10, the combined rank calculation unit 11 and/or the authoritativeness calculation unit 12.

The described memory devices, especially the memory device 7 and/or the memory device 10A may be formed by a hard drive, a flash disc, a USB memory device, a floppy disc, a disc, a CD, a DVD, a Blu-ray disc, a band and/or a removable storage medium. It may be of advantage, that the memory device 7 or the memory device 10A are implemented by a data base server.

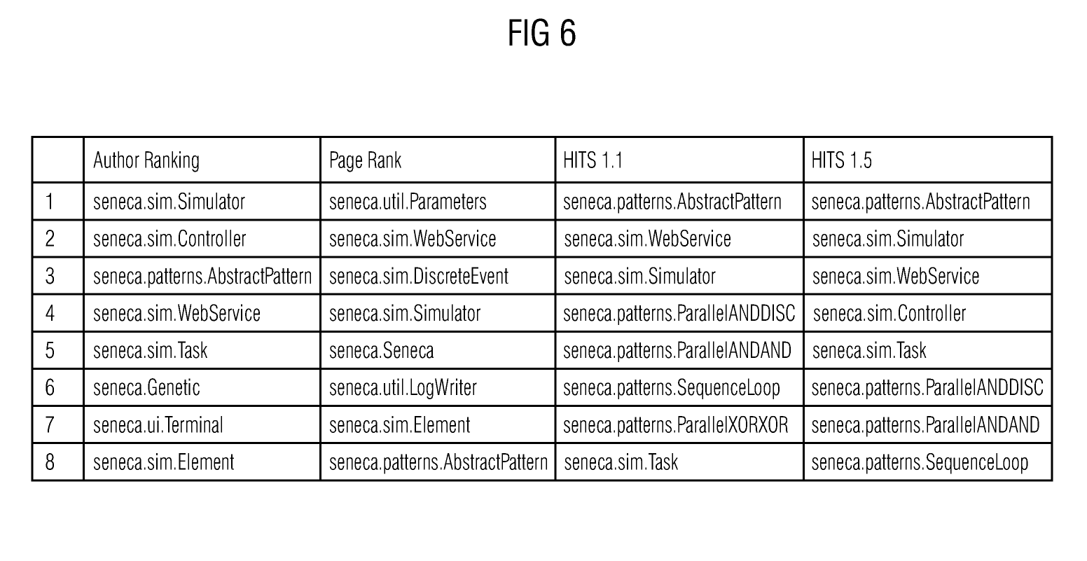

FIG. 6 shows a table illustrating an evaluation of the method for determining an authoritativeness of a first software component with regard to a second software component.

The table shown in FIG. 6 holds a computation of the authoritativeness of software components. In the leftmost column an index of each row is provided. Furthermore, an author ranking is providing, describing a manual ranking of classes, which reflects expert knowledge of a software architect. Furthermore, a column stating the result of the Hub rank algorithm, which was applied for determining the authoritativeness of software components, is provided. Furthermore, a column stating the authoritativeness of software components, calculated by the HITS algorithm is provided. This column shows the results of applying a weighting factor wf of 1. Furthermore a column of evaluation results of a calculation of the authoritativeness is provided, according to the HITS algorithm with application of a weighting factor wf of 5. In each column the software components are ranked according to their authoritativeness as calculated by the respective approach, as indicated in the first row. It can be seen in the table, as represented in FIG. 6, the application of the HITS algorithm with a weighting factor wf of 5 comes closest to the author ranked authoritativeness of the software components. This can, for instance, be evaluated by the software component “seneca.sim.Simulator” and the software component “seneca.sim.Controller”. This evaluation of the described method may be calculated by simulation software.

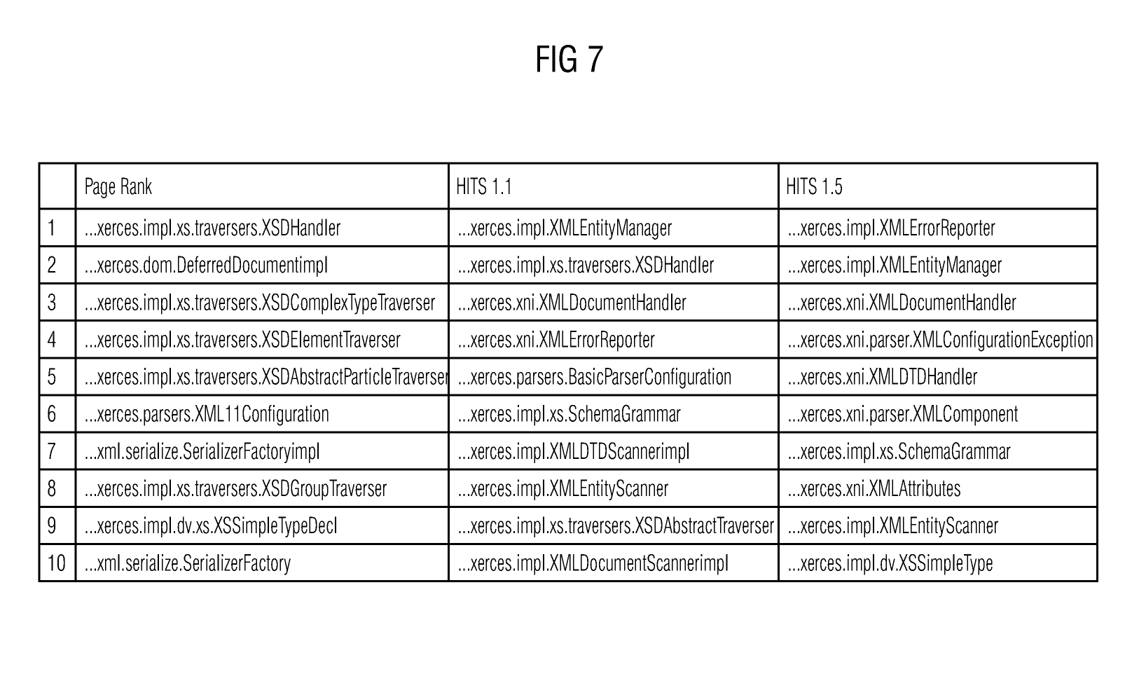

FIG. 7 shows a further table providing evaluation results of the method. Contents of this table are calculated by a second simulation software. The table demonstrates more precise results of the application of the HITS algorithm with a weighting factor wf of 5 compared to the application of the HITS algorithm by a weighting factor wf of 1. Hence, the empirically determined weighting factor wf as described above, delivers more precise results than commonly known methods. Comparing the rightmost column with the column describing results of an application of the PageRank algorithm shows, that the method for determining an authoritativeness according to the method described above delivers more precise results in the technical field of software architecture analysis compared to commonly known methods, which can only defined application in the technical field of search engine technology.

The system also includes permanent or removable storage, such as magnetic and optical discs, RAM, ROM, etc. on which the process and data structures of the present invention can be stored and distributed. The processes can also be distributed via, for example, downloading over a network such as the Internet. The system can output the results to a display device, printer, readily accessible memory or another computer on a network.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

What is claimed is:

1. A method for determining an authoritativeness of a first software component with regard to a second software component, where the first software component invokes an execution of at least one procedure executed by the second software component, comprising:
providing a procedure invocation graph of the first and second software components; and
calculating the authoritativeness of the first software component as a function of an eigenvector of the procedure invocation graph.

2. The method according to claim 1, wherein said providing the procedure invocation graph comprises determining an adjacency matrix defining the procedure invocation graph.

3. The method according to claim 1, wherein the procedure invocation graph has nodes and edges, each node representing one software component and each edge representing a method invocation between the software components.

4. The method according to claim 1, wherein said calculating of the eigenvector uses a Hyperlink-Induced Topic Search algorithm.

5. The method according to claim 1, wherein said calculating of the eigenvector uses a combination of the PageRank algorithm and the Hyperlink-Induced Topic Search algorithm.

6. The method according to claim 5, wherein applying the Hyperlink-Induced Topic Search algorithm comprises calculating at least one of a group of ranks, including a Hub rank and an Authority rank.

7. The method according to claim 4, wherein applying the Hyperlink-Induced Topic Search algorithm comprises calculating at least one of a group of ranks, comprising: a Hub rank and an Authority rank.

8. The method according to claim 7, wherein said calculating of the eigenvector uses a combined rank as a function of the Hub rank and the Authority rank.

9. The method according to claim 8, wherein said calculating includes calculating the combined rank as a function of a summation of the Hub rank and the Authority rank.

10. A method according to claim 1, wherein a software component is at least one of a library, a repository, a module, a package, a class, an interface, a procedure, and a software unit.

11. A computer for determination of an authoritativeness of a first software component with regard to a second software component, where the first software component invokes an execution of at least one procedure executed by the second software component, comprising:
a first device providing a procedure invocation graph of the first and second software components; and
a second device calculating the authoritativeness of the first software component as a function of an eigenvector of the procedure invocation graph.

12. The computer according to claim 11, wherein at least one of the first device and the second device is formed by a calculation unit.

13. A computer-readable medium encoded with a computer program that when executed by a computer causes the computer to perform a method for determining an authoritativeness of a first software component with regard to a second software component, where the first software component invokes an execution of at least one procedure executed by the second software component, the method comprising:
providing a procedure invocation graph of the first and second software components; and
calculating the authoritativeness of the first software component as a function of an eigenvector of the procedure invocation graph.

14. The computer-readable medium according to claim 13, wherein said providing the procedure invocation graph comprises determining an adjacency matrix defining the procedure invocation graph.

15. The computer-readable medium according to claim 13, wherein the procedure invocation graph has nodes and edges, each node representing one software component and each edge representing a method invocation between the software components.

16. The computer-readable medium according to claim 13, wherein said calculating of the eigenvector uses a Hyperlink-Induced Topic Search algorithm.

17. The computer-readable medium according to claim 13, wherein said calculating of the eigenvector uses a combination of the PageRank algorithm and the Hyperlink-Induced Topic Search algorithm.

18. The computer-readable medium according to claim 17, wherein applying the Hyperlink-Induced Topic Search algorithm comprises calculating at least one of a group of ranks, including a Hub rank and an Authority rank.

19. The computer-readable medium according to claim 16, wherein applying the Hyperlink-Induced Topic Search algorithm comprises calculating at least one of a group of ranks, comprising: a Hub rank and an Authority rank.

20. The computer-readable medium according to claim 19, wherein said calculating of the eigenvector uses a combined rank as a function of the Hub rank and the Authority rank.

21. The computer-readable medium according to claim 20, wherein said calculating includes calculating the combined rank as a function of a summation of the Hub rank and the Authority rank.

22. An apparatus for determining an authoritativeness of a first software component with regard to a second software component, where the first software component invokes an execution of at least one procedure executed by the second software component, comprising:
a first unit providing a procedure invocation graph of the first software component and the second software component; and
a second unit calculating the authoritativeness of the first software component as a function of an eigenvector of the procedure invocation graph.
